(19) United States
(12) Patent Application Publication
(10) Pub. No.: US 2004/0150560 A1
(43) Pub. Date: Aug. 5, 2004

(54) Positioning system and method

(76) Inventors: Jun Feng, Cambridge, MA (US); Edward L. Hill, Portsmouth, NH (US)

Correspondence Address: John Christopher, Christopher & Weisberg, P.A., Suite 2040, 200 East Las Olas Boulevard, Fort Lauderdale, FL, 33301, US

(21) Appl. No.: 10/356,379

(22) Filed: Jan. 31, 2003

(51) Int. Cl. G01S 3/02

(52) U.S. Cl. 342/465

(57) ABSTRACT

A positioning system and method provide fast and accurate position of a portable signal transmitter. It is particularly suitable for tracking applications in a local area, e.g., virtual environment. This system includes at least two relay stations, at least one portable signal transmitter, and one central station. The portable signal transmitter emits a tracking signal, which is received by each of the relay stations and then relayed to the central station wirelessly or by a wired connection. Time data are measured either in the central station or in each of the relay stations. A data processor calculates the position coordinates of the portable signal transmitter. The position system can be used to track the location of one object within another object, such as a medical device within a human body.

### CROSS-REFERENCE TO RELATED APPLICATION

This application is based on and claims priority to U.S. patent application Ser. No. 09/690,643, filed Oct. 17, 2000 which claims priority to U.S. Provisional Patent Application No. 60/173,496, entitled POSITIONING SYSTEM, filed on Dec. 29, 1999, the entirety of which are incorporated herein by reference.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of contract No. N68335-97-C-0298 awarded by the United States Navy.

### FIELD OF THE INVENTION

The present invention relates to a new type of positioning system, and more particularly to a tracking system and method for precision positioning applications in a virtual environment.

### BACKGROUND OF THE INVENTION

It has long been recognized that an issue critical to HMD (head-mounted display) virtual reality is how to make a fast, accurate and long range tracking device. Existing technologies for such devices include mechanical, magnetic, optical, ultrasonic and inertial tracking systems. However, these systems have various disadvantages. Mechanical tracking is fast and accurate, but clumsy and only operative over a small range; Magnetic tracking is fast, but too sensitive to metallic interference; Optical devices are fast, but require a strict line-of-sight between devices to operate; Ultrasonic devices are inexpensive, but are vulnerable to sound noise; Inertial devices work over a long range, but are not accurate over time. It is therefore desirable to have a fast, accurate and cordless tracking system operable over a long range.

RF (radio frequency) positioning technologies have been developed since W.W. #II for applications in land-scale navigation. There are two categories of RF positioning systems: self-positioning systems and remote-positioning systems. In a self-positioning system, an object detects its own position based on the data sent out from the system, e.g., GPS (U.S. Pat. No. 5,223,844 to Mansell et al.) and LORAN-C (U.S. Pat. No. 5,032,845 to Velasco et al.). In a remote-positioning system, the position of a remote object is detected by the system, not by the object itself. In other words, the system knows where the object is, but the object does not know where it is, e.g., a radar system and a cellular phone location system (U.S. Pat. No. 5,327,144 to Stilp et al.).

In most of RF positioning systems, the position of an object is determined by measuring time-difference-of-arrival (TDOA). All reference stations are synchronized in this type of system. Typically, they can reach positioning accuracy from inches to meters. However, their applications in millimeter-scale positioning such as head trackers are limited by difficulties to further improve accuracy due to various system errors including timing errors for signals-traveling in circuits, synchronization errors, etc.

U.S. Pat. No. 5,374,936 to Feng discloses a remote-positioning system, which eliminates the need to synchronize all receiving stations, and minimizes system errors by applying a dynamic calibration method. It is desirable to have a system like that in U.S. Pat. No. 5,374,936 which is operable in a one-dimensional co-ordinate system, employs a simplified central station and allows system operation without a calibration station.

It is also desirable to have a positioning system, which uses RF technologies in a local area, e.g., a virtual environment, and which makes tracking fast and accurate in a long-range space.

### SUMMARY OF THE INVENTION

The present invention provides a local positioning system and method which use RF signals to reach a very high accuracy, for example up to mm-scale, with a very high update rate, e.g., 500 Hz or more in an indoor or outdoor environment.

The present invention adapts Feng to be more suitable for use in local precision tracking.

Key features of the present invention include: (a) suitability for use in one-dimensional coordinates, e.g., in a street or in a corridor; (b) an improved calibration method, (c) the calibration station is not necessary in certain embodiments, and (d) a simplified central station.

The present invention provides a tracking system, which uses RF technologies in a local area, e.g., a virtual environment. The invention makes tracking fast and accurate in a long-range virtual space.

The present invention provides a positioning system, in which there is at least one portable signal transmitter. The portable signal transmitter transmits a first tracking signal. A calibration station is positioned at a predetermined location and has a transmitter, which transmits a first calibration signal. A plurality of relay stations are positioned at predetermined locations, in which each relay station has a relay station receiver receiving the first tracking signal and the first calibration signal, a transmitter responsive to the relay station receiver transmits a second tracking signal substantially upon receipt of the first tracking signal and transmits a second calibration signal substantially upon receipt of the first calibration signal. A central station has a central station receiver, a timer and a data processor. The central station receiver receives the second tracking signal and the second calibration signal from the relay stations. The timer measures time intervals between the signals, e.g., between the second tracking signals from each selected pair of relay stations, and between the second calibration signals from each selected pair of relay stations. The data processor calculates position coordinates of the portable signal transmitter.

According to another aspect, the present invention provides a system similar to the above-described system but without the calibration station. A calibration point with known position (e.g., the starting track point of a portable signal transmitter) is used to calibrate the tracking signal. An optional synchronizing station emits a synchronizing signal to synchronize the tracking signals from multiple signal transmitters.

According to still another aspect, the present invention provides a system similar to the above-described system, but the timer is positioned in each relay station. The timer measures a time interval between an incoming tracking signal and a reference signal from a reference signal generator, and measures a time interval between an incoming calibration signal and the reference signal. Alternatively, the timer directly measures the time intervals between the incoming tracking and calibration signals. A data signal including all the time data is sent from each of the relay stations to the central station, which calculates the signal transmitter's position.

As still yet another aspect, the present invention provides a system similar to the above-described system, but the timer is positioned in each relay station and there is no calibration station. A calibration point with known position (e.g., the starting track point of a portable signal transmitter) is used to calibrate the tracking signal. An optional synchronizing station emits a synchronizing signal to synchronize the tracking signals from multiple signal transmitters.

According to another aspect, the present invention provides a method for determining the position of a signal transmitter, in which a first tracking signal is transmitted. A first calibration signal is transmitted from a known location by using a preset period or at the time when a user enables a calibration station. Alternatively, a first tracking signal transmitted from a known location is regarded as a first calibration signal. The first tracking signal and the first calibration signal are received at a plurality of known locations. From each of the plurality of known locations, a second tracking signal is transmitted in response to receiving the first tracking signal, and a second calibration signal is transmitted in response to receiving the first calibration signal. The second tracking signals and the second calibration signals are received. At least one of the time intervals is measured, e.g., the time intervals between each selected pair of the second tracking signals, the time intervals between each selected pair of the second calibration signals, the time intervals between the second tracking signal and the second calibration signal, the time intervals between the second tracking signal and a reference signal, the time intervals between the second calibration signal and a reference signal. Position coordinates of the signal transmitter are determined.

According to still another aspect, the present invention provides a method for determining the position of a signal transmitter, in which a tracking signal is transmitted. A calibration signal is transmitted from a known location by using a preset period or at the time when a user enables a calibration station. Alternatively, a tracking signal transmitted from a known location is regarded as a calibration signal. The tracking signal and the calibration signal are received at a plurality of known locations. At least one of the time intervals is measured, e.g., the time intervals between the tracking signal and the calibration signal, the time intervals between the tracking signal and a reference signal, the time intervals between the calibration signal and a reference signal. From each of the plurality of known locations, a data signal including all time data is transmitted. The data signals are received. Position coordinates of the signal transmitter are determined.

With respect to each of the embodiments, the exact type of calibration method and time measurement is not a limitation as other techniques are contemplated.

Yet another aspect of the invention is a positioning system for tracking or identifying the location of a first object within a second object. For example, a portable transmitter capable of emitting a signal is placed within a human body. A group of receivers detect the signal. Signals from the receivers are processed to determine the location of the transmitter within the body.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

For the purpose of illustrating the invention, there is shown in the drawings a form that is presently preferred, it being understood, however, that the invention is not limited to the precise arrangement and instrumentalities shown.

FIG. 1 is a block diagram of a first embodiment of a positioning system constructed in accordance with the principles of the present invention;

FIG. 2 is a block diagram of an exemplary relay, calibration and central station for the first embodiment of the positioning system shown in FIG. 1;

FIG. 3 is an exemplary flow chart of a tracking and calibration signal process for the first embodiment of the positioning system shown in FIG. 1;

FIG. 4 is a block diagram of a second embodiment of a positioning system constructed in accordance with the principles of the present invention;

FIG. 5 is a block diagram of an exemplary relay, synchronizing and central station for the second embodiment of the positioning system shown in FIG. 4;

FIG. 6 is an exemplary flow chart of a tracking and synchronizing signal process for the second embodiment of the positioning system shown in FIG. 4;

FIG. 7 is a block diagram of a third embodiment of a positioning system constructed in accordance with the principles of the present invention;

FIG. 8 is a block diagram of an exemplary relay, calibration and central station for the third embodiment of the positioning system shown in FIG. 7;

FIG. 9 is an exemplary flow chart of a tracking and calibration signal process for the third embodiment of the positioning system shown in FIG. 7;

FIG. 10 is a block diagram of a fourth embodiment of a positioning system constructed in accordance with the principles of the present invention;

FIG. 11 is a block diagram of an exemplary relay, synchronizing and central station for the fourth embodiment of the positioning system shown in FIG. 10;

FIG. 12 is an exemplary flow chart of a tracking and synchronizing signal process for the fourth embodiment of the positioning system shown in FIG. 10;

FIG. 13 is a schematic diagram of an exemplary system that embodies the features of the present invention.

### DETAILED DESCRIPTION OF THE INVENTION

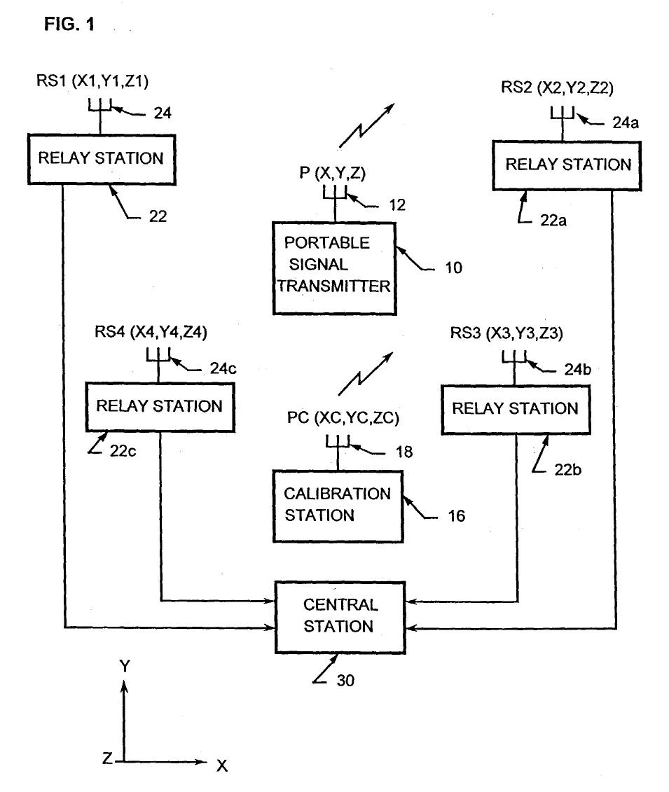

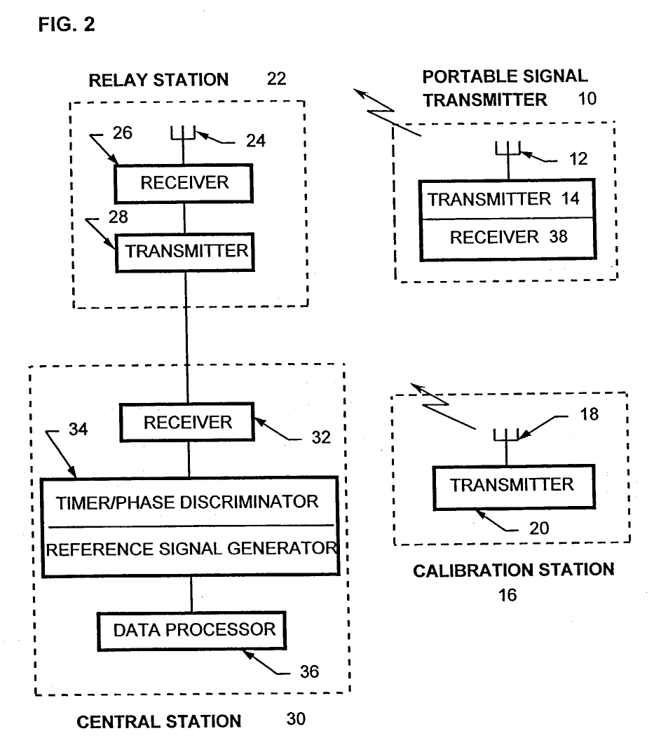

Referring to the drawing figures in which like reference designators refer to like elements, there are shown in FIGS. 1 and 2 block diagrams of a first embodiment of a positioning system for the present invention capable of identifying the position of a portable signal transmitter 10 (also referred to as “P”) in one, two or three dimensional coordinates.

The portable signal transmitter 10 includes an antenna 12 and a transmitter 14, and transmits a first tracking signal. A calibration station 16 (also referred to as “PC”) is positioned at a predetermined location having known coordinates (xc, yc, zc). The calibration station 16 includes an antenna 18 and a transmitter 20, and transmits a first calibration signal using a preset period or at the time when a user enables the calibration station. Four relay stations RS1 22, RS2 22a, RS3 22b and RS4 22c generally referred to 22 are positioned at predetermined locations having known coordinates (x1,y1,z1), (x2,y2,z2), (x3,y3,z3) and (x4,y4,z4) respectively. Only four relay stations are required to find the coordinates of a portable signal transmitter in a three dimensional coordinate system. However if extra relay stations are provided, the measured data can be used to improve the positioning accuracy. In a two-dimensional coordinate system (e.g., x-y plane), a minimum of three relay stations (e.g., 22, 22a, 22b) is required. In a one-dimensional coordinate system (e.g., x axis), a minimum of two relay stations (e.g., 22, 22a) is required. Each of the relay stations 22, 22a, 22b, and 22c includes an antenna 24, 24a, 24b, 24c, a receiver 26, a transmitter 28, receives the first tracking and calibration signal, and transmits a second tracking and calibration signal. A central station 30 includes a receiver 32, a precision timer 34 and a data processor 36, and receives, measures and processes the time data.

As used herein, the term “signal” includes, but is not limited to, any portion of the electromagnetic spectrum suitable for transmission of information over distance, such as one or more modulated microwave frequencies, impulses, one or more CDMA (code division multiple access) signals with spread spectrum frequency etc. Other type of waves such as audio, acoustic, and ultrasonic waves are considered as part of the term “signal”. The signal may be continuous or pulse-modulated. The signal may be transmitted between relay and central stations either through a wired connection or wirelessly. The signals may be distinguished from each other, e.g., by individual identification codes or pulse widths, or by different frequencies, or by different time divisions, etc.

The precision timer 34 is a time measurement device or process such as a DLL (delay lock loop), a circuit, a time counter, a microprocessor, a digital signal processor, a clock, a phase discriminator, or other hardware and/or software. The time measurement may include direct measurement between two incoming signals, or indirect measurement between an incoming signal and a reference signal from a reference signal generator. The time data multiplied by the signal velocity is distance data. Therefore, time data and distance data are equivalent and mutually convertible. The time measurement also may include phase measurement by a phase discriminator. A phase discriminator is a device or process to measure the signal phase. The measured phase data can be converted into time data, and therefore, the phase data are regarded as part of the time data.

An incoming signal is sent to the timer for time measurement directly, or the incoming signal can be down-converted to middle/low frequency and sent to the timer for time measurement. Time measurement is calculated between two analog signals, or the analog signals can be converted to digital by an A/D converter and a digital signal processor used to measure the time data. The receivers may include one or more signal processing elements, e.g., amplifier, filter, divider, multiplier, mixer, decoder and analog-digital converter. The data processor 36 may include an element for phase-to-time conversion, in which data processor 36 fuses all data together and processes all necessary data calculations.

For some special applications such as TDMA (time division multiple access) for multiple-users, the portable signal transmitter 10 also includes a receiver 38 to receive the first calibration signal for synchronizing the tracking signals from different users.

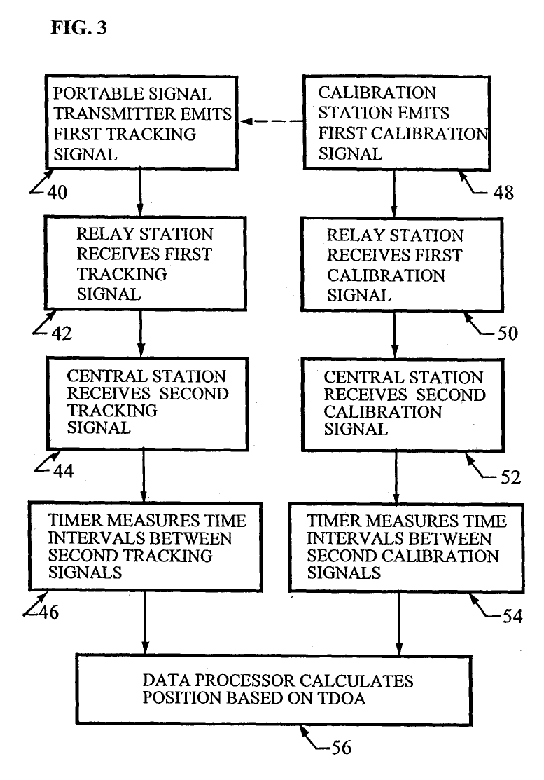

FIG. 3 shows a flow chart of the tracking and calibration signal process for the first embodiment of the present invention. As shown in FIG. 3, a first tracking signal is emitted from a portable signal transmitter (step 40) and is received by each of the relay stations (step 42). Each of the relay stations then substantially immediately relays the tracking signal (referred as a second tracking signal) to the central station wireless or by a wired connection. The second tracking signal carries all information of the first tracking signal including time and phase. The central station receives the second tracking signals from the relay stations (step 44), and the timer measures time intervals between two incoming second tracking signals for each selected pair of relay stations (step 46). For example, the measured time intervals are referred to as Δ₂₁, Δ₃₁ and Δ₄₁, for a pair of second tracking signals from the relay stations 2 and 1, from relay stations 3 and 1, and from the relay stations 4 and 1 respectively.

A first calibration signal is emitted from the calibration station (step 48), and is received by each of the relay stations (step 50). The calibration signal is substantially immediately relayed to the central station (referred as a second calibration signal) wireless or by a wired connection (step 52) for time interval measurement (step 54) in the same way as the second tracking signal. Following the convention in the above example for the second tracking signal, the measured time interval data for the second calibration signal are referred to as Δc_{21, Δc}₃₁ and Δc₄₁, respectively.

Alternatively, it is contemplated that the timer measures the time intervals between a second tracking signal and a second calibration signal from each of relay stations. Or, the timer measures the time intervals between a second tracking/calibration signal and a reference signal. These time interval measurements are equivalent and mutually convertible.

A set of calibrated time data (e.g., Δt₂₁, Δt₃₁ and Δt₄₁, abbreviated to Δtᵢⱼ) are thus obtained from the above-measured time data by relations, e.g.,

Δtᵢⱼ=Δctᵢⱼ−Δcᵢⱼ+Δᵢⱼ(i,j=1,2,3,4),

where: Δtᵢⱼ is a calibrated time interval of a tracking signal from a portable signal transmitter to the relay stations RS(i) and RS(j). Δctᵢⱼ (i,j=1,2,3,4) is a theoretical time interval of a calibration signal from the calibration station to the relay stations RS(i) and RS(j). They can be obtained either by experimentation or by calculations from predetermined positions of the calibration station and the relay stations.

The coordinates of the portable signal transmitter P(x, y, z) are then calculated by solving a set of equations (step 54), e.g.

$$\begin{matrix}Δ {t}_{ij} = \frac{\sqrt{{( {x}_{i} - x )}^{2} + {( {y}_{i} - y )}^{2} + {( {z}_{i} - z )}^{2}}}{ν} - \frac{\sqrt{{( {x}_{j} - x )}^{2} + {( {y}_{j} - y )}^{2} + {( {z}_{j} - z )}^{2}}}{ν} \\ ( i , j = 1 , 2 , 3 , 4 ) .\end{matrix}$$

The dashed line in FIG. 3 from step 48 to 40 indicates an optional application in which the portable signal transmitter receives a first calibration signal to activate a first tracking signal.

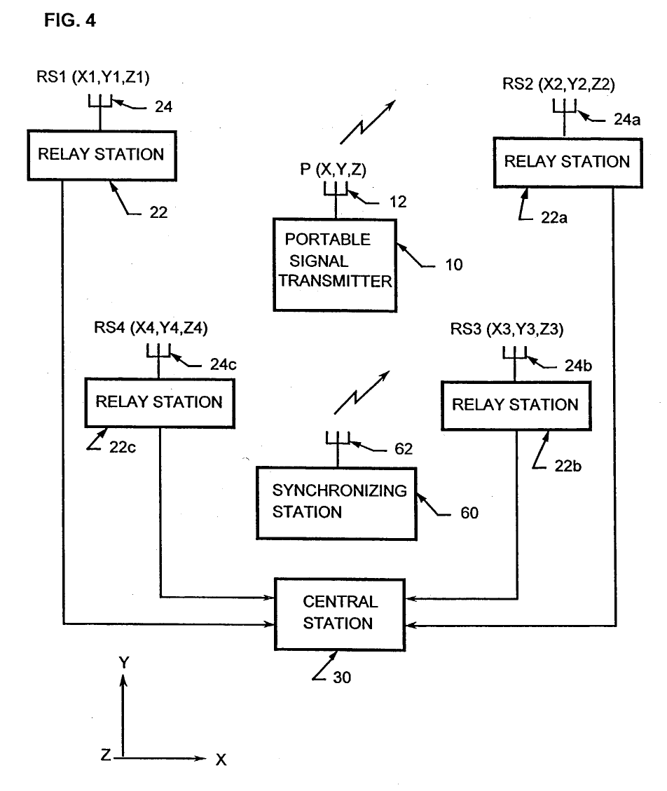

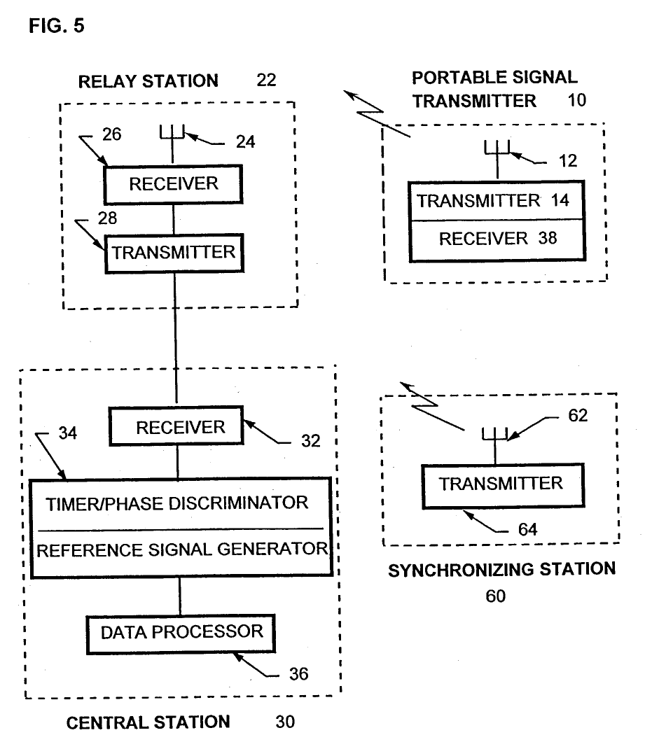

FIGS. 4 and 5 show block diagrams of a second embodiment of the present invention. The second embodiment is similar to the first embodiment, but the calibration station is removed. An optional synchronizing station 60 including an antenna 62 and a transmitter 64 emits a synchronizing signal, which is then received by the receiver 38 in the portable signal transmitter 10 to activate a first tracking signal.

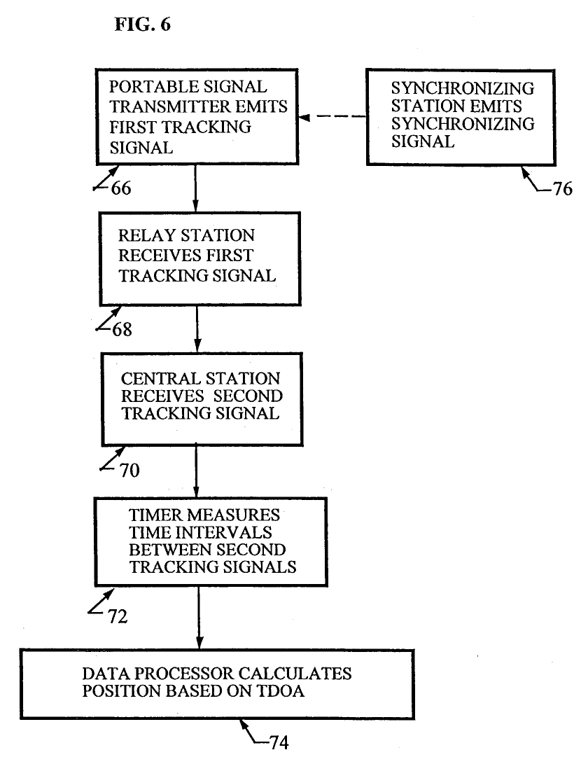

FIG. 6 is an exemplary flow chart of a tracking and synchronizing signal process for the second embodiment of the present invention shown in FIG. 4. A first tracking signal is emitted from a portable signal transmitter (step 66), and is received by each of the relay stations (step 68). Each of the relay stations then substantially immediately relays the tracking signal (referred as a second tracking signal) to the central station wireless or by a wired connection. The central station receives the second tracking signals from the relay stations (step 70), and the timer measures the time intervals between two incoming second tracking signals for each pair of relay stations referred as Δᵢⱼ (i, j=1,2,3,4) (step 72). Alternatively, the timer measures the time intervals between a second tracking signal and a reference signal. These time interval measurements are equivalent and mutually convertible.

The calibrated time data for calculating the coordinates of the portable signal transmitter are obtained based on their relations, e.g.,

Δtᵢⱼ=Δctᵢⱼ′−Δcᵢⱼ′+Δᵢⱼ(i,j=1,2,3,4),

where: Δctᵢⱼ′ is a theoretical time interval of a tracking signal from a calibration point with known position (e.g., a starting track point of the portable signal transmitter) to the relay stations RS(i) and RS(j). Δcᵢⱼ′ is a measured time interval between second tracking signals when the portable signal transmitter is at the calibration point. The data processor in the central station then calculates the coordinates of the portable signal transmitter by a set of equations (step 74).

Step 76 indicates an optional application in which the synchronizing station emits a synchronizing signal, which is received by the portable signal transmitter to activate a first tracking signal.

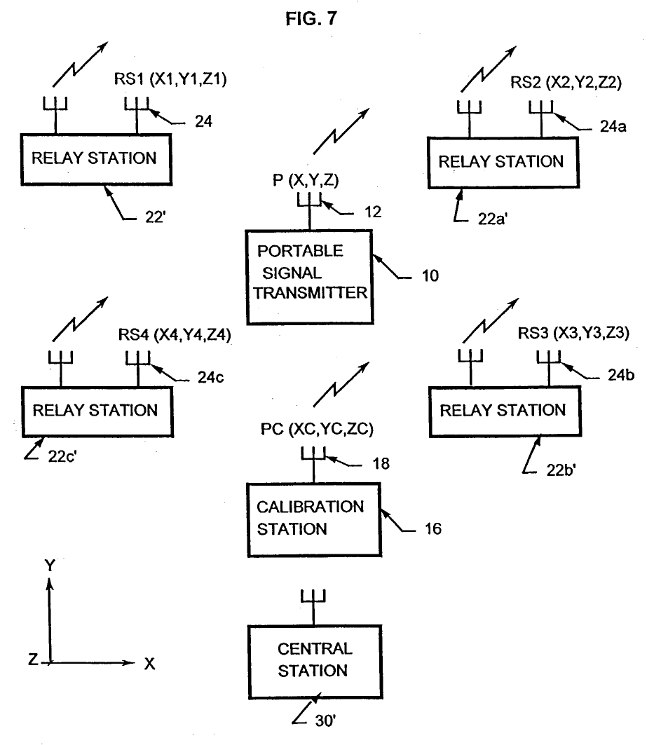

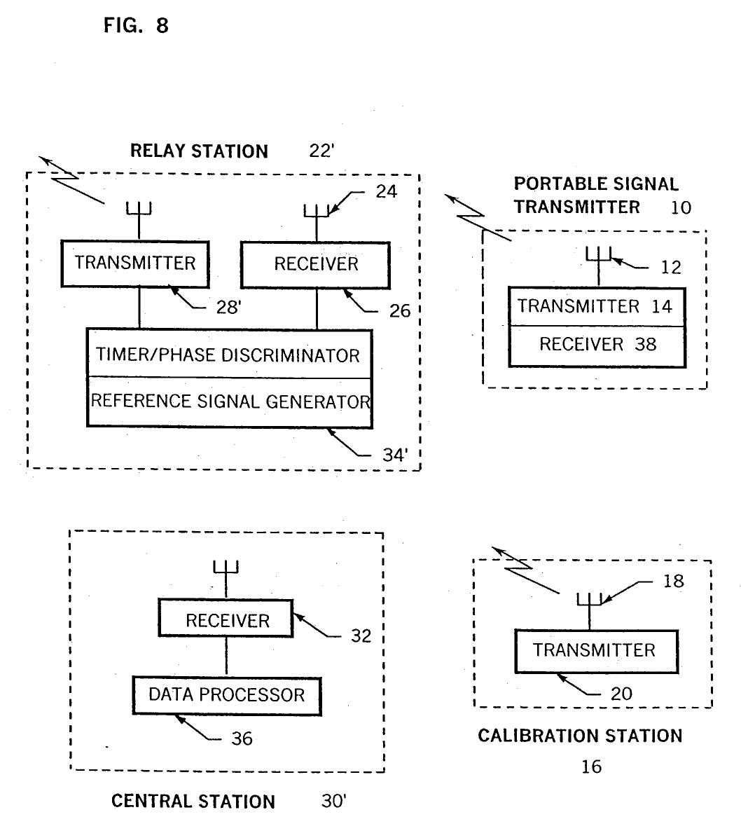

FIGS. 7 and 8 show block diagrams of a third embodiment of the present invention. The third embodiment is similar to the first embodiment shown in FIGS. 1 and 2, but the precision timer 34′ is removed from the central station, and is included as part of each of the relay stations 22′, 22a′, 22b′, 22c′. Each of the relay stations 22′, 22a′, 22b′, 22c′ includes an antenna 24, 24a, 24b, 24c, a receiver 26, a transmitter 28′ and a timer 34′ for receiving a track signal and a calibration signal, measuring time data, and transmitting a data signal. A central station 30′ includes a receiver 32 and a data processor 36 for receiving the data signals and processing the time data.

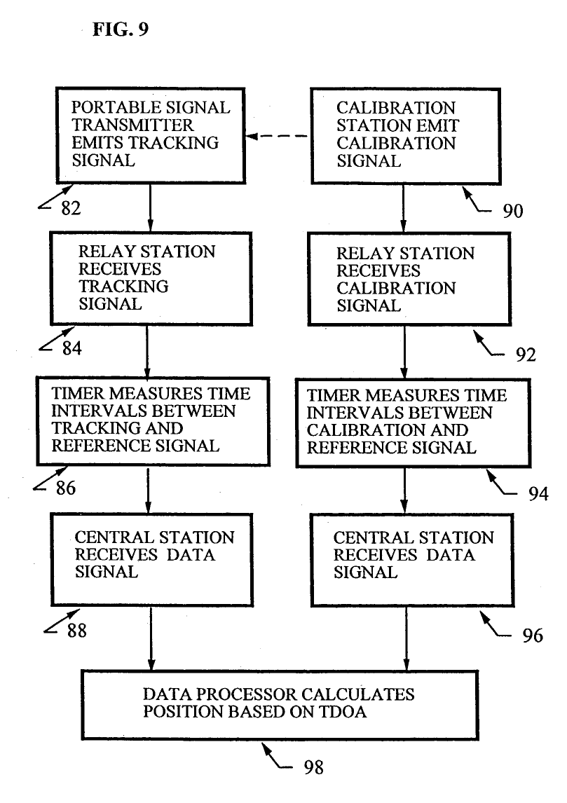

FIG. 9 is an exemplary flow chart of a tracking and calibration signal process for the third embodiment of the present invention. A tracking signal is emitted from the portable signal transmitter (step 82), and is received by each of the relay stations (step 84). The timer measures time intervals between the incoming tracking signal and a reference signal, e.g., δtᵢ for the relay station RS(i) (step 86). A calibration signal is emitted using a preset period or at the time the calibration station is enabled by a user, from the calibration station (step 90) and is received by each of the relay stations (step 92). The timer measures time intervals between the incoming calibration signal and the reference signal, e.g., δctᵢ for the relay station RS(i) (step 94). Each of the relay stations then sends a data signal including these time data, wirelessly or by wired connection, to the central station (step 88 and step 96) for use by a process that calculates the coordinates of the portable signal transmitter (step 98). The time interval Δtᵢ between the incoming tracking and calibration signal at the relay station RS(i) is the difference between δtᵢ and δtᵢ. The calibrated time data Δtᵢⱼ are thus:

Δtᵢⱼ=Δctᵢⱼ−Δtᵢ+Δtⱼ(i,j=1,2,3,4),

where Δctᵢⱼ (i, j=1,2,3,4) is a theoretical time interval of a calibration signal from the calibration station to pair of relay stations RS(i) and RS(j). The time intervals can be obtained either by experimentation or by calculations from predetermined positions of the calibration station and the relay stations. Alternatively, the time interval measurement in each of the relay stations can be directly made between the incoming tracking and calibration signal. These time interval measurements are equivalent and mutually convertible.

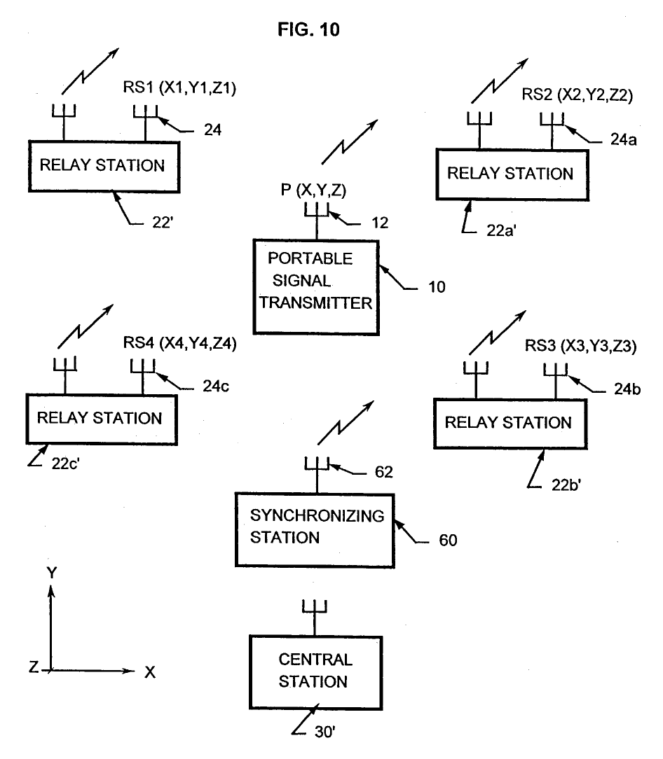

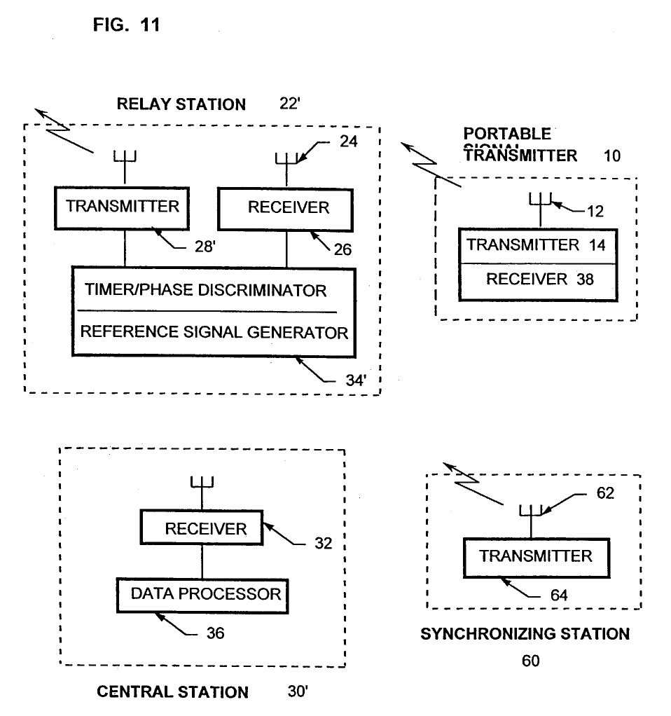

FIGS. 10 and 11 show block diagrams of a fourth embodiment of the present invention. The fourth embodiment is similar to the third embodiment shown in FIGS. 7 and 8, but the calibration station is not included. An optional synchronizing station 60 includes an antenna 62 and a transmitter 64, which emits a synchronizing signal to synchronize the tracking signals from multiple signal transmitters.

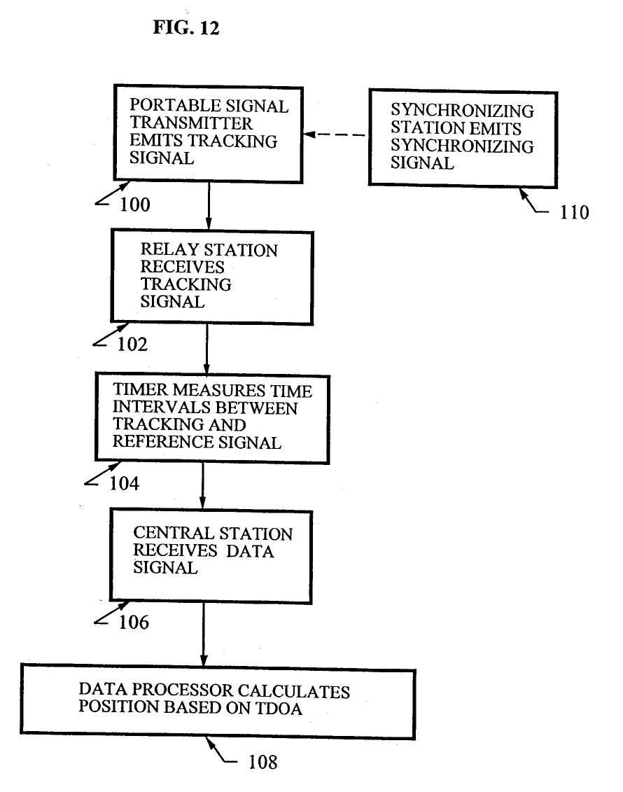

FIG. 12 shows an exemplary flow chart of a tracking and synchronizing signal process for the fourth embodiment of the present invention. A tracking signal is emitted from a portable signal transmitter (step 100) and is received by each of the relay stations (step 102). The timer measures time intervals between the incoming tracking signal and a reference signal for each relay station (step 104). Each of the relay stations then sends a data signal including these time data, wirelessly or by wired connection, to the central station (step 106). The data processor calculates the coordinates of the portable signal transmitter (step 108) by using the calibrated time data as:

Δtᵢⱼ=Δctᵢⱼ′Δtᵢ′+Δtⱼ′(i,j=1,2,3,4),

where: Δctᵢⱼ′ is a theoretical time interval of a tracking signal from a calibration point with known position (e.g., a starting track point of the portable signal transmitter) to pair of relay stations RS(i) and RS(j); Δtᵢ′ and Δt^{j}′ are the measured time data increments of a tracking signal relative to the time data when the portable signal transmitter is at the calibration point for relay station RS(i) and RS(j) respectively. Step 110 indicates an optional application in which a synchronizing station emits a synchronizing signal, which is received by the portable signal transmitter to activate a tracking signal.

As should be readily appreciated, the above teachings are applicable to many applications where position determination is desired. For example, the system can be used to locate position in a large geographic territory, a location within a building, or a position within a room. It can even be employed to locate objects with precision in very confined spaces. For example, in an exemplary application, a position detection system is provided that uses radio frequency communication between one or more transmitters and a group of receivers to identify the position, track, and/or map movement of a first object within a second object. More specifically, the system can be used to track objects placed into the human body.

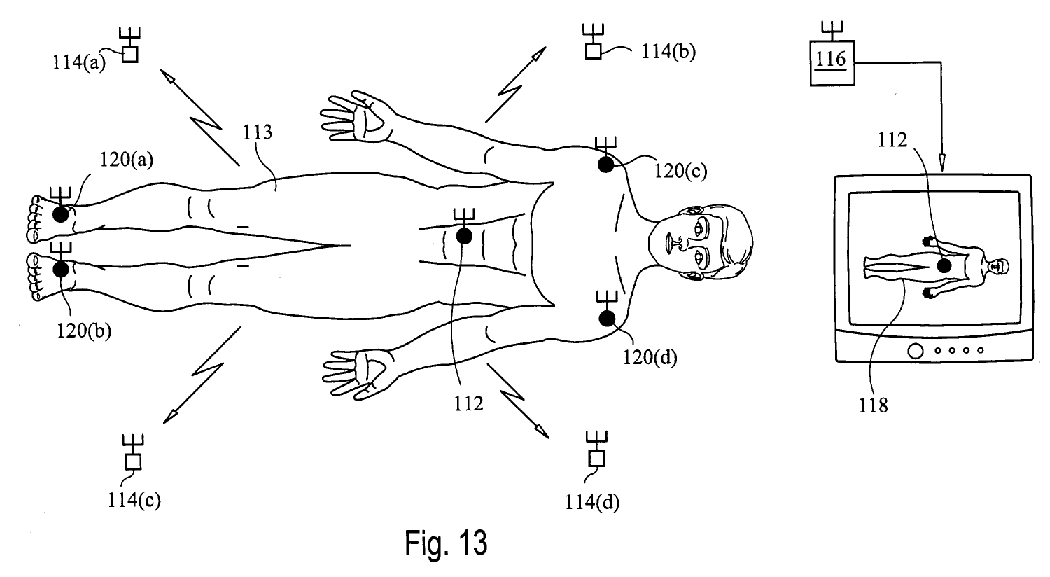

Referring now to FIG. 13, an exemplary system is illustrated wherein an object 112 to be tracked, located or mapped includes a transmitter capable of emitting a coded signal as described above. In the exemplary system, the signals are wide-band, spread spectrum radio frequency signals or ultra wide-band signals. Although the object 112 can simply be a transmitter, it can also include additional elements such as chemical or electrical sensors, viewing or imaging devices, biopsy or collection devices or chambers, and drug or beneficial agent delivery mechanisms. Additionally, although the object 112 can be a discrete element that can be swallowed, injected or otherwise introduced into a body 113 with the expectation that it remain in the introduced location or migrate therefrom, the object can be tethered to or integral with other system components, such as a probe or a catheter having a transmitting tip.

A group of receivers 114 are disposed in selected locations so as to be able to receive signals emitted by the transmitter. In the exemplary system, the no less than four receivers 114 are located within the medical treatment room at precise locations (in an x-y-z coordinate system) so as to be in a predetermined orientation with respect to the body 113 into which the object 112 is to be introduced. The signal(s) emitted from the object 112 is/are received by the receivers 114 and analyzed with respect to the time of reception and/or with respect to phase information of each signal received. The time and data recorded from the received signals are used to calculate the three dimensional physical location of the object 112 with respect to the body 113.

The receivers 114 are in wired or wireless communication with a central station 116 that processes the signals from the receivers 114 as described above and outputs data that can be used to represent position of the object 112 within the body 113. In the exemplary system, position data is presented on a display and overlaid onto an image of the body that was previously created with ultrasound, MRI, CAT, PET, or other medical imaging techniques known to those skilled in the art.

The spatial position and orientation of the body 113 can be maintained on the medical image of the body 118 by securely positioning the body in a predetermined location and orientation with mechanical fixation devices, by using magnetic inertial posture sensing techniques, or by placing additional transmitters 120 onto the body. The fixed transmitters 120 placed onto the body 113 can be correlated with the digital image of the body 118 at the time the image is created and thus used as reference points on the digital image. The reference points' spatial positions, generated in the same way as the position information of the object 112, can be tracked and correlated with the points recorded on the digital image. The correlation will allow the digital image to compensate for any movement of the body 113 during the procedure while the object 112 is inside the body.

Many other variations and modifications and other uses will become apparent to those skilled in the art. It is preferred, therefore, that the present invention be limited not by the specific disclosure herein, but only by the appended claims.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A positioning system for identifying the location of a first object within a second object, the system comprising:
a signal transmitter capable of emitting a first coded signal, wherein the first object includes the signal transmitter;
a plurality of receivers positioned at predetermined locations, each receiver capable of receiving the first coded signal emitted from the signal transmitter and outputting a second coded signal substantially upon receipt of the first coded signal; and
a central station in communication with the plurality of receivers for processing the second coded signal from each of the plurality of receivers to determine a three-dimensional coordinate position of the signal transmitter.

2. The positioning system of claim 1, wherein the second object is a human body and wherein the signal transmitter is implantable within the human body.

3. The positioning system of claim 1, wherein the second object is a human body and wherein the signal transmitter is ingestible within the human body.

4. The positioning system of claim 1, wherein the second object is a human body and further including a medical device that is introducible into the human body, wherein the signal transmitter is in communication with the medical device.

5. The positioning system of claim 1, wherein the second object is a human body and wherein the signal transmitter is integral with the medical device.

6. The positioning system of claim 5, wherein the medical device includes a catheter.

7. The positioning system of claim 5, wherein the medical device is capable of sensing biological function.

8. The positioning system of claim 5, wherein the medical device includes an imaging device.

9. The positioning system of claim 1, wherein the medical device includes a tissue-sampling device.

10. The positioning system of claim 1, wherein the plurality of receivers include at least four receivers.

11. The positioning system of claim 10, wherein each of the plurality of receivers are located at predetermined locations.

12. The positioning system of claim 1, further comprising a plurality of transmitters secured to the second object, and wherein the transmitters each emit a coded signal received by the plurality of receivers, each receiver capable of receiving the coded signal emitted from the transmitters and outputting a second coded signal substantially upon receipt of the first coded signal, and wherein the central station is in communication with the plurality of transmitters for processing the second coded signal from each of the plurality of receivers to determine a three dimensional coordinate position of the plurality of signal transmitters.

13. The positioning system of claim 1, wherein the three-dimensional coordinate position of the signal transmitter is correlated with medical image data.

14. The positioning system of claim 12, wherein the three dimensional coordinate position of the signal transmitters secured to the second object are correlated with the three dimensional coordinate position of the first object.

15. The positioning system of claim 14, wherein the three-dimensional coordinate position of the signal transmitter secured to the second object and the three dimensional coordinate position of the first object are correlated with medical image data.

16. A positioning system for identifying the location of a transmitter within a human body the system comprising:
a signal transmitter capable of emitting a first coded signal;
at least four receivers positioned at predetermined locations, each receiver capable of receiving the first coded signal emitted from the signal transmitter and outputting a second coded signal substantially upon receipt of the first coded signal; and
a central station in communication with the plurality of receivers for processing the second coded signal from each of the plurality of receivers to determine a three dimensional coordinate position of the signal transmitter,
wherein the three-dimensional coordinate position of the signal transmitter is correlated with medical image data.

17. The positioning system of claim 16, the signal transmitter is ingestible within the human body.

18. The positioning system of claim 16, further including a medical device that is introducible into the human body, wherein the signal transmitter is integral with the medical device.

19. The positioning system of claim 16, further comprising a plurality of transmitters secured to the human body, and wherein the transmitters each emit a coded signal received by the plurality of receivers, each receiver capable of receiving the coded signal emitted from the transmitters and outputting a second coded signal substantially upon receipt of the first coded signal, and wherein the central station is in communication with the plurality of transmitters for processing the second coded signal from each of the plurality of receivers to determine a three dimensional coordinate position of the plurality of signal transmitters.

20. The positioning system of claim 19, wherein the three dimensional coordinate position of the signal transmitter the three dimensional coordinate position of the plurality of transmitters are correlated with medical image data.
